(19) United States
(12) Patent Application Publication
(10) Pub. No.: US 2026/0003062 A1
(43) Pub. Date: Jan. 1, 2026

(54) ID TAG AND DETECTING SYSTEM

(71) Applicants: NTT, Inc., Tokyo (JP); The University of Tokyo, Tokyo (JP)

(72) Inventors: Tatsuya IIZUKA, Musashino-shi, Tokyo (JP); Go Itami, Musashino-shi, Tokyo (JP); Naoko KOSAKA, Musashino-shi, Tokyo (JP); Masato MARUYAMA, Musashino-shi, Tokyo (JP); Toshimitsu TANAKA, Musashino-shi, Tokyo (JP); Akira KOYAMA, Musashino-shi, Tokyo (JP); Jun KATO, Musashino-shi, Tokyo (JP); Takuya SASATANI, Bunkyo-ku (JP); Koya NARUMI, Bunkyo-ku (JP); Yoshihiro KAWAHARA, Bunkyo-ku (JP)

(21) Appl. No.: 18/850,301

(22) PCT Filed: Mar. 31, 2023
(86) PCT No.: PCT/JP2023/013655

§ 371 Date: Apr. 15, 2025

(30) Foreign Application Priority Data
Apr. 5, 2022 (JP) 2022-062858

(51) Int. Cl. G01S 13/75; G06K 19/077

(52) U.S. Cl. CPC G01S 13/75; G06K 19/07749

(57) ABSTRACT

A plurality of IDs are presented by chipless RFID using an object shape as an ID. Provided is an ID tag for arranging in a row a plurality of elements selected from: a first element having a peak of a reflection intensity in a first direction and a second direction; a second element having the peak of the reflection intensity in the first direction and having no peak of the reflection intensity in the second direction; a third element having the peak of the reflection intensity in the second direction and having no peak of the reflection intensity in the first direction; and a fourth element having no peak of the reflection intensity in the first direction and the second direction.

### TECHNICAL FIELD

The present invention relates to an ID tag and a detecting system.

### BACKGROUND

Recently, chipless RFID has attracted attention (Non-Patent Literature 1). The chipless RFID is a RFID (radio frequency identifier) that can be realized without an IC (integrated circuit). The chipless RFID is expected to be an environmentally friendly technology that can be sensed by radio waves.

Spatial-domain s also included in the chipless RFID. Spatial-domain chipless RFID has a unique tag shape, and an object shape is used as an ID of a tag. Signals of irradiated radio waves reflected or scattered on a tag surface is analyzed to obtain the ID. The spatial-domain Chipless RFID has many advantages, as described below.

### (1) High Degree of Freedom with Respect to Constituent Materials

The spatial-domain chipless RFID can work with materials that reflect radio waves, so that the materials are not limited to conductive materials. The spatial-domain chipless RFID are not limited to conductive materials, so that they have a low environmental impact. The spatial-domain chipless RFID can guarantee low visibility because its shape is specified by radio waves, and visibility can be controlled.

### (2) Low Cost with Respect to Tag Manufacturing Cost

Conventional chipless has an antenna size RFID approximately corresponding to a wavelength. The higher the frequency, the higher the required antenna processing accuracy, and thus the higher the manufacturing cost. On the other hand, the spatial-domain chipless RFID does not require an antenna structure, so that it can be manufactured at low cost.

### (3) Increase in the Amount of Information that can be Stored

It is possible to embed a higher amount of information per area by applying high-resolution radar imaging techniques such as a SAR (Synthetic Aperture Radar) technology, (Non-Patent Literature 2).

The spatial-domain Chipless RFID, for example, has a CR (corner reflector) shape. A structure having a robust a reading angle in reading accuracy has been proposed for the chipless RFID having the CR shape. The chipless RFID having the CR shape is readable over a wide range (Non-patent Literature 3).

### CITATION LIST

### Non-Patent Literature

Non-Patent Literature 1: H, Cristian, et al., “Chipless-RFID: a review and recent developments.” Sensors, 2019, 19, 3385

Non-Patent Literature 2: M, Zomorrodi, et al., “Optimized MIMO-SAR technique for fast EM-imaging of chipless RFID system.” IEEE Transactions on Microwave Theory and Techniques, 2017, 65, 2, 661-669.

Non-Patent Literature 3: Katelyn R, Brinker, et al., “Corner Reflector Based Misalignment-Tolerant Chipless RFID Tag Design Methodology.” IEEE Journal of Radio Frequency Identification, 2021, 5, 1, 94-105.

### SUMMARY OF THE INVENTION

### Technical Problem

However, the conventional chipless RFID using the object shape as the ID cannot present a plurality of IDs by a single chipless RFID system.

The present invention has been made in view of the above circumstances, and an object of the present invention is to provide a technology capable of presenting a plurality of IDs by chipless RFID having an object shape as an ID.

### Solution to Problem

An ID tag according to one aspect of the present invention for arranging in a row a plurality of elements selected from selected from a first element having a peak of a reflection intensity in a first direction and a second direction; a second element having the peak of the reflection intensity in the first direction and having no peak of the reflection intensity in the second direction; a third element having the peak of the reflection intensity in the second direction and having no peak of the reflection intensity in the first direction; and a fourth element having no peak of the reflection intensity in the first direction and the second direction.

A detecting system according to one aspect of the present invention includes the ID tag; a radar device which transmits a transmission radio wave to the ID tag in a direction opposite to the first direction and a direction opposite to the second direction, and acquires a first reception radio wave by reflecting the transmission radio wave transmitted in the first direction by the ID tag, a second reception radio wave by reflecting the transmission radio wave transmitted in the second direction by the ID tag; and a detecting device which detects a first ID from a relationship between a distance and a reflection intensity in the first reception radio wave and detects a second ID from a relationship between a distance and a reflection intensity in the second reception radio wave.

### Effects of Invention

According to the present invention, it is possible to provide a technology capable of presenting a plurality of IDs by chipless RFID having an object shape as an ID.

### BRIEF DESCRIPTION OF DRAWINGS

FIG. 1 is a diagram illustrating an ID tag and a detecting system for detecting an ID of the ID tag according to an embodiment of the present invention.

FIG. 2 is a diagram illustrating a direction in which each element used for the ID tag has a peak of a reflection intensity.

FIG. 3 is a diagram illustrating an example of arrangement of the elements in the ID tag.

FIG. 4 is a diagram illustrating the reflection intensity of a corner reflector.

FIG. 5 is a perspective view illustrating an example of each element.

FIG. 6 is a diagram illustrating an example of the reflection intensity of each element shown in FIG. 5.

FIG. 7 is a view illustrating an example of applying the ID tag according to an embodiment of the present invention to a road sign.

### DESCRIPTION OF EMBODIMENTS

Embodiments of the present invention will now be described with reference to the drawings. In the description of the drawings, the same reference numerals are used for the same components, and description thereof is omitted.

### Detecting System

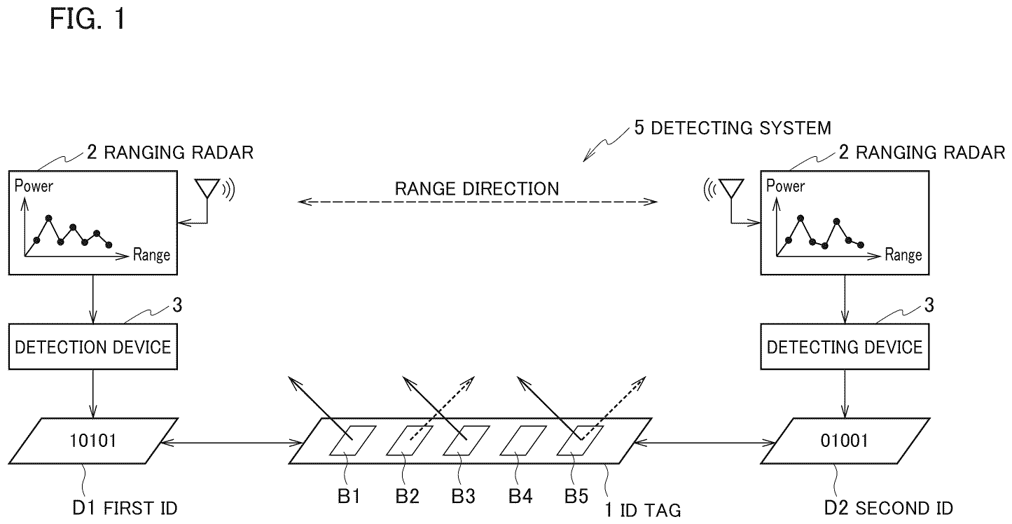

A detecting system 5 according to an embodiment of the present invention will be described with reference to FIG. 1. The detecting system 5 includes an ID tag 1, a ranging radar 2, and a detecting device 3.

The ID tag 1 presents an ID in a plurality of directions. The ID tag shown in FIG. 1 presents different IDs in two directions, a first direction (a solid line direction) and a second direction (a dashed line direction).

The ranging radar 2 transmits a transmission radio wave to the ID tag 1 from obliquely above and receives a reception radio wave reflected by the ID tag 1.

In the example shown in FIG. 1, the ranging radar 2 transmits the transmission radio wave in a direction opposed to the first direction and a direction opposed to the second direction. The ranging radar 2 transmits the transmission radio wave toward the ID tag 1 from a point in the first direction (solid line direction). The ranging radar 2 transmits a transmission radio wave toward the ID tag 1 from a point in the second direction (dashed line direction). The ranging radar 2 transmits a transmission radio wave from a position at which the reception radio wave can be received from the ID tag 1.

The ranging radar 2 acquires a first reception radio wave by reflecting the transmission radio wave transmitted in a direction opposite to the first direction by the ID tag 1, and a second reception radio wave by reflecting the transmission radio wave transmitted in a direction opposite to the second direction by the ID tag 1. The transmission radio wave is, for example, a millimeter wave or a microwave. The reception radio wave indicates a correspondence between a distance from a position of the ranging radar 2 and the reflection intensity. The distance from the position of the ranging radar 2 is calculated from the time after the ranging radar 2 receives the transmission radio wave.

The detecting device 3 specifies the ID indicated by the ID tag 1 from the received radio wave received by the ranging radar 2. In the example shown in FIG. 1, the detecting device 3 detects the first ID from the relationship between the distance and the reflection intensity in the first reception radio wave, and the second ID from the relationship between the distance and the reflection intensity in the second reception radio wave.

The ID tag 1 includes elements corresponding to a plurality of bits constituting an ID presented by the ID tag 1. In the example shown in FIG. 1, the ID tag 1 includes elements corresponding to each of five bits B1 to B5. The elements corresponding to the bits B1 to B5 are evenly spaced. The ID tag 1 is an element arranged in each bit and presents an ID of up to five bits in the first direction and the second direction.

Elements selected from the following four types are arranged in the positions of the bits B1 to B5 of the ID tag 1.

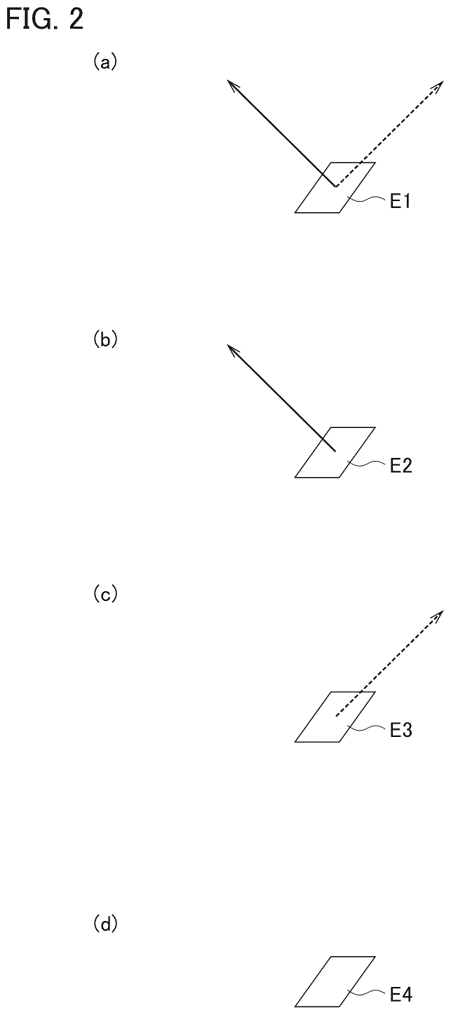

(1) As shown in FIG. 2(a), a first element E1 has a peak of a reflection intensity in a first direction and a second direction. The first element E1 has the reflection intensity stronger than a predetermined threshold in the first direction and the second direction.

(2) As shown in FIG. 2(b), a second element E2 has the peak of the reflection intensity in the first direction and does not have a peak of the reflection intensity in the second direction. The second element E2 has the reflection intensity stronger than the predetermined threshold in the first direction and the reflection intensity weaker than a predetermined threshold in the second direction.

(3) As shown in FIG. 2(c), a third element E3 has the peak of the reflection intensity in the second direction and no peak of reflection intensity in the first direction. The third element E3 has the reflection intensity stronger than the predetermined threshold in the second direction and the reflection intensity weaker than the predetermined threshold in the first direction.

(4) A fourth element E4 has no reflection intensity peaks in the first and second directions. The fourth element E4 has the reflection intensity weaker than the predetermined threshold in the first and second directions.

In each bit of the ID tag 1, the elements selected from the first element to the fourth element are arranged in a row. The row for arranging the plurality of elements coincides a line projecting the first direction on a surface for arranging the plurality of elements, and a line projecting the second direction on the surface for arranging the plurality of elements. In FIG. 1, the direction in which the elements in the ID tag 1 are arranged is referred to as a range direction.

The ranging radar 2 transmits the transmission radio wave from a position in the first direction and a position in the second direction. The direction from the ranging radar 2 to the ID tag 1 is referred to as a slant range direction. The row of the elements in the ID tag 1 coincides with a ground range direction, that is, the range direction, in which the slant range direction is projected on an arrangement surface of the ID tag 1.

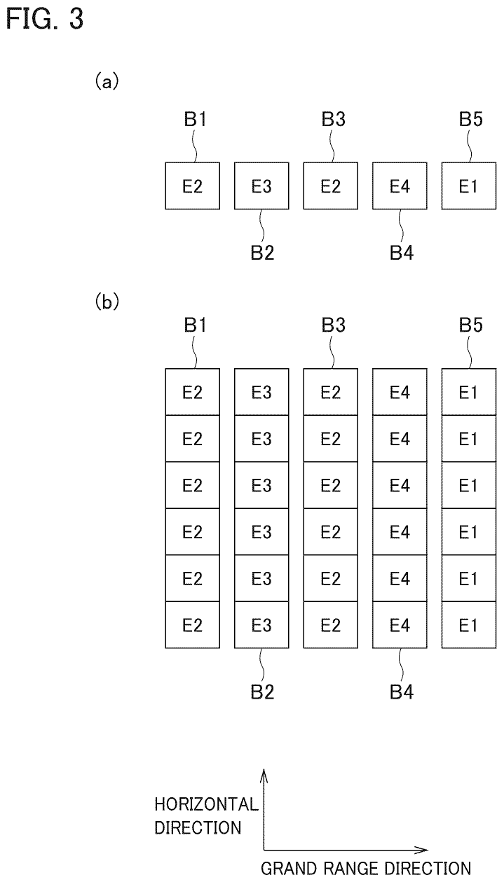

FIG. 3(a) shows types of elements arranged in each bit of the ID tag 1 shown in FIG. 1. FIG. 3(a) shows the types of the elements arranged in each bit when viewing the ID tag 1 shown in FIG. 1 from a top surface. In the example shown in FIG. 1, the second element E2 is arranged in the bits B1 and B3 of the ID tag 1, the third element E3 is arranged in the bit B2, the fourth element E4 is arranged in the bit B4, and the first element E1 is arranged in the bit B5. Each element is arranged in a row in the ground range direction.

Two adjacent elements on the ID tag 1 are arranged so that the ranging radar 2 can identify the two elements in the range direction. The ranging radar 2 can specify the reflection intensity for each distance to each element from the reception radio wave.

The first reception radio wave obtained by irradiating the ID tag 1 with the transmitted radio wave from a position in the first direction specifies a distance from the ranging radar 2 to each bit, specifically, the strength of the reflection intensity at each bit position. The detecting device 3 can specify the ID presented by the ID tag 1 in the first direction from the reflection intensity at each bit position indicated by the first reception radio wave. When the reflection intensity for each bit position is larger than the predetermined threshold value, the information indicated by the bit position is “1”, and when the reflection intensity for each bit position is smaller than the predetermined threshold value, the information indicated by the bit position is “0”. In the example shown in FIG. 1, the elements having the peak in the first direction are arranged at the positions of B1, B3 and B5, and the elements having no peak in the first direction are arranged at the positions of B2 and B4. The first reception radio wave has the reflection intensity stronger than the threshold value at the positions of B1, B3 and B5, and the reflection intensity weaker than the threshold value at the positions of B2 and B4. The detecting device 3 can detect “10101” as a first ID D1 from the first reception radio wave.

Similarly, the second reception radio wave obtained by irradiating the ID tag 1 with the transmission radio wave from a position in the second direction specifies the distance from the ranging radar 2 to each bit, specifically, the strength of the reflection intensity at each bit position. The detecting device 3 can specify the ID presented by the ID tag 1 in the second direction from the reflection intensity at each bit position indicated by the second reception radio wave. When the reflection intensity for each bit position is larger than a predetermined threshold value, the information indicated by the bit position is “1”, and when the reflection intensity for each bit position is smaller than the predetermined threshold value, the information indicated by the bit position is “0”. In the example shown in FIG. 1, the elements having the peak in the second direction are arranged at the positions of B2 and B5, and the elements having no peak in the second direction are arranged at the positions of B1, B3 and B4. The second reception radio wave has the reflection intensity stronger than the threshold value at positions of B2 and B5, and the reflection intensity weaker than the threshold value at positions of B1, B3 and B4. The detecting device 3 can detect “01001” as a second ID D2 from the second reception radio wave.

The ID tag 1 shown in FIG. 1 can present a 5-bit ID by arranging five elements in a row, but the number of bits of the ID to be presented may be adjusted by the number of elements arranged in the ID tag 1. By arranging more elements in the ID tag 1, the number of bits of the ID to be presented can be increased and a larger amount of information can be presented.

In FIG. 3(a), a case in which one element is arranged in each bit has been described, but as shown in FIG. 3(b), a plurality of elements may be arranged in each bit. The plurality of the elements are arranged in a direction orthogonal to the direction in which the plurality of the elements selected from the four elements are arranged in the same order as the order in which the plurality of the elements are arranged. In FIG. 3(a), the second element E2, the third element E3, the second element E2, the fourth element E4, and the first element E1 are arranged in this order in each of the bits B1 to B5 in the ground range direction. In FIG. 3(b), six rows of the second element E2, the third element E3, the second element E2, the fourth element E4, and the first element E1 are arranged in the direction orthogonal to the ground range direction (horizontal direction) on the arrangement surface of the ID tag 1. In FIG. 3(b), one bit is formed by a plurality of elements of the same type in the horizontal direction. The number of elements provided in each bit increases, so that the reflection intensity for the transmission radio wave can be amplified, and it is possible to present the ID to the ranging radar 2 at a more distant position. The distance between the ID tag and the ranging radar 2 capable of detecting the ID presented by the ID tag 1 can also be adjusted by the number of elements provided in each bit.

### Elements

Next, an example of the first element E1 to the fourth element E4 will be described. The first element E1 to the fourth element E4 are formed by a combination of, for example, a corner reflector having a triangular pyramid shape and a planar member.

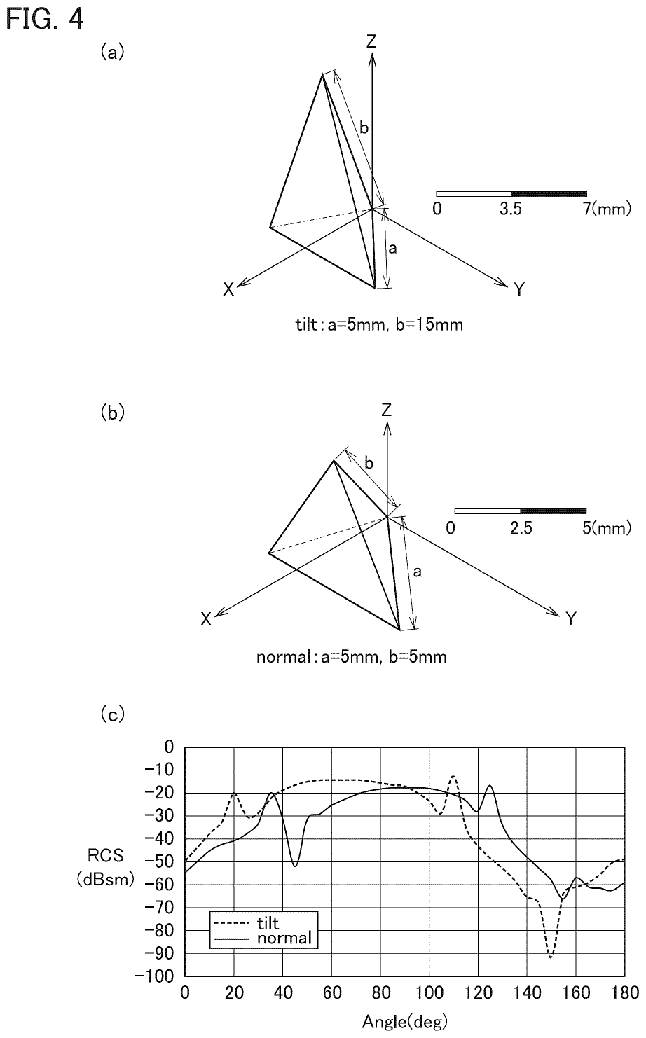

A general corner reflector is formed of a reflection member having a regular triangular pyramid shape as shown in FIG. 4(b). The corner reflector having a regular triangular pyramid shape as shown in FIG. 4(b) is formed with each side having a length of 5 mm, and a hypotenuse to a base has all the same length. On the other hand, in the embodiment of the present invention, as shown in FIG. 4(a), the corner reflector having a triangular pyramid shape formed of the reflection member with a side changed in length is used for the element. The corner reflector having a triangular pyramid shape shown in FIG. 4(a) has one hypotenuse of 15 mm and two hypotenuses of 5 mm among three hypotenuses to the base.

The angle characteristics of the corner reflectors of FIGS. 4(a) and 4(b) are shown in FIG. 4(c). In FIG. 4(c), a dashed line is an angular characteristic of the corner reflector in FIG. 4(a), and a solid line is a characteristic of the corner reflector in FIG. 4(b). In FIG. 4C, a vertical axis is the reflection intensity, and a horizontal axis is an angle between the origin and a measurement position of the reflection intensity in a XZ plane.

The corner reflector shown in FIG. 4(a) has peaks near 20 degrees and 110 degrees, while the corner reflector shown in FIG. 4(b) has peaks near 35 degrees and 125 degrees. As shown in FIG. 4(c), the angular characteristic of the reflection intensity varies depending on the shape of the reflection member. According to the embodiment of the present invention the elements are formed using a corner reflector having a peak of the reflection intensity in a desired direction by adjusting the length of one side of the corner reflector.

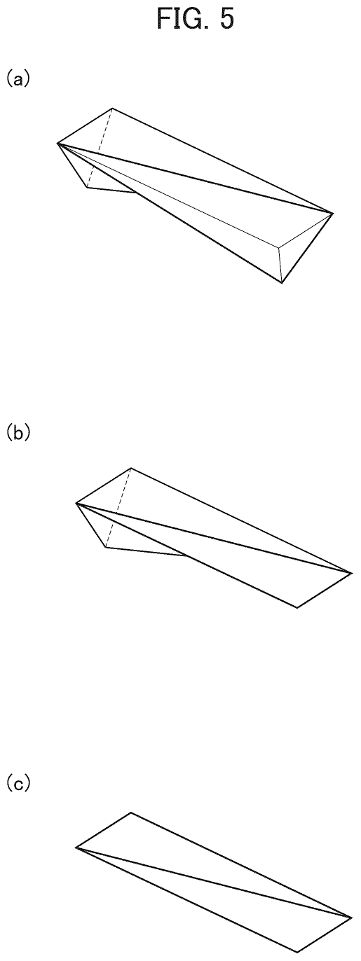

An example of the elements used in the embodiment of the present invention will be described with reference to FIG. 5. Each element is formed by combining one or more reflection members having a triangular pyramid shape in which at least one hypotenuse is different from another hypotenuse in length and one or more reflection members having a planar shape. The reflection member having the triangular pyramid shape in which at least one hypotenuse is different from another hypotenuse in length has a peak in a particular direction, as described with reference to FIG. 4. The reflection member having the planar shape does not have a peak in the reflection intensity in a particular direction. Even if the ranging radar 2 positioned in an obliquely upward direction transmits the transmission radio wave to the reflection member having the planar shape, the reflection intensity in the reception radio wave relative to the transmission radio wave is small.

FIG. 5(a) is an example of the first element E1. In FIG. 5(a), the first element E1 is formed by arranging two reflection members having a triangular pyramid shape in which at least one hypotenuse is different from another hypotenuse in length, with point symmetry. The element shown in FIG. 5(a) is formed by arranging with point symmetry in a top view such that one side of the bases of the two triangular pyramidal shapes coincides with each other with bottom surfaces of the reflection members having two triangular pyramid shapes facing upwards. In the element shown in FIG. 5(a), the reflection members having two triangular pyramid shapes having peaks in a predetermined direction are arranged with point symmetry in the top view. The element shown in FIG. 5(a) is applicable to the first element E1 due to a large scattering cross section and the peaks of reflection intensities in the first and second directions. Here, the lines of the first and second directions projected onto the arrangement surface of the elements are formed in a straight line.

FIG. 5(b) shows an example of a second element E2 or a third element E3. The second element E2 and the third element E3 are each formed of a reflection member having a triangular pyramid shape in which at least one side is different from another side in length and a reflection member having a planar shape. The reflection member having the plane shape has the same triangular shape as the base of the triangular pyramid shape. The element shown in FIG. 5(b) is formed by arranging the base of the reflection member having one triangular pyramid shape upward, and arranging the triangular planar member so that one side of the base of the triangular pyramid shape coincides. The element shown in FIG. 5(b) includes the reflection member having the triangular pyramid shape and having a peak in a predetermined direction, and the reflection member having a planar shape and having no peak in a specific direction. The element shown in FIG. 5(b) is applicable to the second element E2 or the third element E3 since it has a peak of reflection intensity due to a high scattering cross section in a predetermined direction and no peak of reflection intensity due to a low scattering cross section in another direction. Here, a line projecting each of the predetermined direction having a peak and the other direction having no peak on the arrangement surface of the element is formed in a straight line. Note that the element shown in FIG. 5(b) becomes the second element E2 by arranging the direction in which the reflection intensity reaches peaks in the first direction, and becomes the third element E3 by arranging the direction in which the reflection intensity reaches peaks in the second direction.

FIG. 5(c) is an example of a fourth element E4. The fourth element E4 is formed of the reflection member having a planar shape. The element shown in FIG. 5(c) is formed so that the hypotenuses of the two triangle-shaped planar members coincide. The element shown in FIG. 5(c) is formed of the reflection member having the planar shape that does not have the peak in a specific direction and does not include the reflection member having the peak in a specific direction. The element shown in FIG. 5(c) is applicable to the fourth element E4 since it has no peak in either direction due to a low scattering cross section.

Each element shown in FIGS. 5(a) to 5(c) is formed of two members selected from the reflection member having a triangular pyramid shape and a triangular reflection member having the same shape as the base of the triangular pyramid shape. Each element is arranged so that the hypotenuses of the two triangular shapes coincide in the top view, so that the area and the shape in the top view are the same. Thus, each element can be interchangeably arranged on the substrate on which the plurality of the elements can be arranged, so that the ID tag 1 can be used universally. The ID tag 1 can also be produced at a low cost.

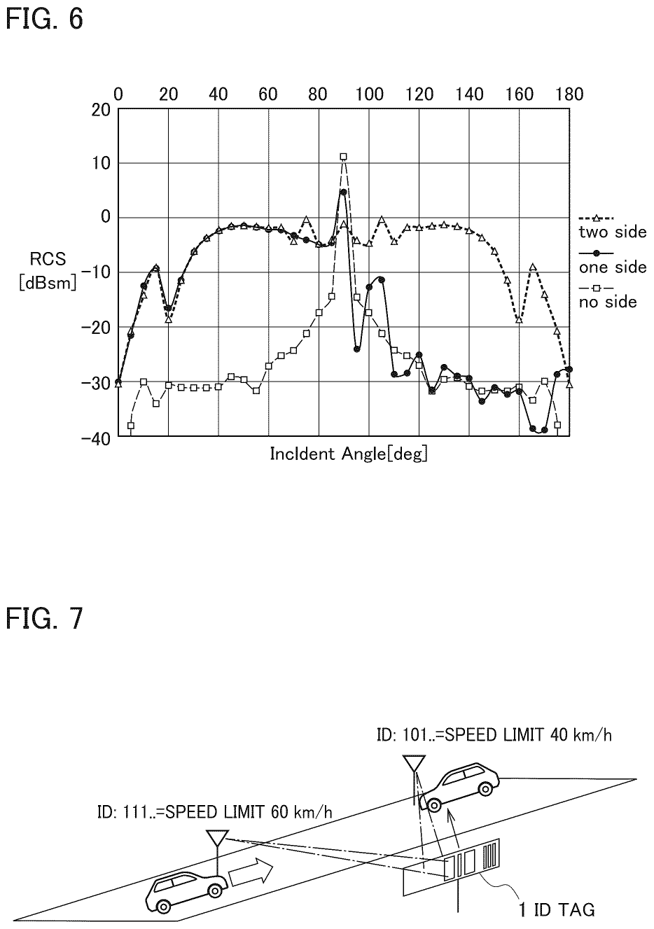

Referring to FIG. 6, an example of the reflection intensities in the three shapes shown in FIG. 5 will be described. A horizontal axis in FIG. 6 is an elevation angle for each element. The elevation angle is shown from 0 to 180 degrees, with 90 degrees directly above the element and 0 and 180 degrees in a horizontal direction. A vertical axis is the reflection intensity.

As shown in FIG. 5(a), “two side” is an element formed by arranging two reflection members having a triangular pyramid shape in which at least one hypotenuse is different from another hypotenuse in length, with point symmetry. As shown in FIG. 5(b), “one side” is an element formed of the reflection member having a triangular pyramid shape in which at least one side is different from another side in length of the hypotenuse, and the reflection member having a planar shape. As shown in FIG. 5(c), “no side” is an element formed of the reflection member having a planar shape.

The reflection intensity of the “two side” is high at both lower and higher angles than 90 degrees elevation angle. The reflection intensity of the “one side” is high at an angle lower than 90 degrees elevation angle and low at an angle higher than 90 degrees elevation angle. The reflection intensity of the “one side” is low both at angles lower than and higher than 90 degrees elevation angle.

Thus, each of the elements shown in FIG. 5 has the peak of the reflection intensity in a desired direction and can be employed in the elements mounted in the ID tag 1.

### Application Example

Referring to FIG. 7, an example of applying the ID tag 1 according to an embodiment of the present invention to a road sign will be described.

In the example shown in FIG. 7, the ID tag 1 is installed on a side of a road on which an automobile can pass in both directions. A millimeter wave radar mounted on the automobile is used for reading the ID tag 1.

In the ID tag 1, the plurality of the elements are arranged in a row in a traveling direction of the automobile. In the example shown in FIG. 7, a longitudinal direction of the ID tag 1 is the traveling direction and the range direction shown in FIG. 1.

The ID tag 1 can present different IDs to automobiles in the different traveling directions. The detecting device 3 mounted on the automobile has in advance a table for associating the IDs presented by the ID tag 1 with road signs corresponding to the IDs. The detecting device 3 acquires the IDs presented by the ID tag 1 from a reception radio wave acquired by the millimeter wave radar, and converts the acquired IDs into the road sign by referring to the table. The detecting device 3 outputs the converted road sign to a display and the like in the automobile.

In the example shown in FIG. 7, the ID tag 1 can present ID=“101 . . . ” to an automobile coming from the other side toward the front. The detecting device 3 mounted on the automobile coming from the back toward the front, converts the ID “101 . . . ” to a road sign “speed limit 40 km/h” by referring to the table, and displays the converted road sign “speed limit 40 km/h”.

The ID tag 1 can present ID=“111 . . . ” to the vehicle going from the front toward the back. The detecting device 3 mounted on the vehicle driving from the front to the back converts the ID “111 . . . ” to a road sign “speed limit 60 km/h” by referring to the table, and displays the converted road sign “speed limit 40 km/h”.

In this way, the ID tag 1 can present different IDs to the automobiles in different driving directions. In the example shown in FIG. 7, the ID tag 1 installed on the side of the road has been described, but without limitation thereto. The two adjacent elements on the ID tag 1 should be installed so that the millimeter wave radar mounted on the automobile can identify the two elements in the range direction.

The millimeter wave radar generally mounted on the automobile is a 79 GHz or 77 to 81 GHz a FMCW (Frequency Modulated Continuous Wave) radar with a distance resolution of 37.5 mm. For example, assuming that the length of the ID tag 1 in the range direction (longitudinal direction) is 1 m, the length in the width direction (traverse direction) is 0.2 m, and the reading conditions are incident angles of 60 degrees and −60 degrees, the ID tag 1 can present 10 bits of information if the range direction of the element installed in 1 bit is smaller than 10 centimeters. The distance between the centers of the elements is 10 centimeters apart from each other, so that the FMCW radar can measure the reflection intensity from each element. Currently, there are 107 types of road signs in Japan: 27 warning signs, 66 control signs, and 14 indicator signs, and the ID tag 1 with greater than or equal to 7 bits can present all road sign types.

In the application example, the ID tag 1 is read by the millimeter wave radar, so that the ID tag 1 can read the ID presented by the millimeter wave even when rain or fog exists in the air such as in rainy weather, dense fog, or when visibility is poor at night or at other times. By increasing the output of millimeter wave radar, ID tag 1 can be read from a more distant position.

The ID tag 1 according to the embodiment of the present invention is read by the millimeter wave radar mounted on an automobile. The millimeter wave radar is mounted on many automobiles for measuring the distance between vehicles. It is possible for a general automobile to read the ID tag 1 without incurring a cost in mounting the radar.

It should be noted that the present invention is not limited to the above embodiments, and many variations are possible within the scope of the outline thereof.

### REFERENCE SIGNS LIST

1 ID tag
2 Ranging radar
3 Detector
5 Detecting system

1. An ID tag for arranging in a row a plurality of elements selected from:
a first element having a peak of a reflection intensity in a first direction and a second direction;
a second element having the peak of the reflection intensity in the first direction and having no peak of the reflection intensity in the second direction;
a third element having the peak of the reflection intensity in the second direction and having no peak of the reflection intensity in the first direction; and
a fourth element having no peak of the reflection intensity in the first direction and the second direction.

2. The ID tag according to claim 1, wherein the plurality of the elements selected are arranged in a direction orthogonal to a direction in which the plurality of the elements are arranged in the same order as the order in which the plurality of elements are arranged.

3. The ID tag according to claim 1, wherein the first element is formed by arranging two reflection members having a triangular pyramid shape in which at least one hypotenuse is different from another hypotenuse in length, with point symmetry.

4. The ID tag according to claim 1, wherein the second element and the third element are each formed of a reflection member having a triangular pyramid shape in which at least one hypotenuse is different from another hypotenuse in length, and a reflection member having a planar shape.

5. The ID tag according to claim 1, wherein the fourth element is formed of the reflection member having a planar shape.

6. The ID tag according to claim 1, wherein the row for arranging the plurality of elements coincides a line projecting the first direction on a surface for arranging the plurality of elements, and a line projecting the second direction on the surface for arranging the plurality of elements.

7. A detecting system comprising:
the ID tag according to claim 1;
a radar device which transmits a transmission radio wave to the ID tag in a direction opposite to the first direction and a direction opposite to the second direction, and acquires a first reception radio wave by reflecting the transmission radio wave transmitted in the first direction by the ID tag, a second reception radio wave by reflecting the transmission radio wave transmitted in the second direction by the ID tag; and
a detecting device which detects a first ID from a relationship between a distance and a reflection intensity in the first reception radio wave and detects a second ID from a relationship between a distance and a reflection intensity in the second reception radio wave.
